(19) United States
(12) Patent Application Publication
(10) Pub. No.: US 2025/0062496 A1
(43) Pub. Date: Feb. 20, 2025

(54) ELECTROCHEMICAL DEVICE AND ELECTRONIC DEVICE

(71) Applicant: Ningde Amperex Technology Limited, Ningde (CN)

(72) Inventors: Chenchen LI, Ningde (CN); Ping HE, Ningde (CN); Daolin LIU, Ningde (CN)

(73) Assignee: Ningde Amperex Technology Limited, Ningde (CN)

(21) Appl. No.: 18/938,632

(22) Filed: Nov. 6, 2024

Related U.S. Application Data
(63) Continuation of application No. PCT/CN2022/091223, filed on May 6, 2022.

(51) Int. Cl. H01M 50/48; H01M 50/112; H01M 50/141; H01M 50/193; H01M 50/198

(52) U.S. Cl. CPC H01M 50/48; H01M 50/112; H01M 50/141; H01M 50/193; H01M 50/198

(57) ABSTRACT

An electrochemical device, including a first housing, a second housing, and a first separation piece. The first separation piece is disposed between the first housing and the second housing. A first cavity and a second cavity are disposed on two sides of the first separation piece of the electrochemical device respectively. The first separation piece includes a first substrate layer and a first sealing material layer located on a surface of the first substrate layer. The electrochemical device satisfies: 1.2≤Fₛ₁₁/F₁₁≤15, where F₁₁ is a peel force between the first sealing material layer and the first substrate layer, and Fₛ₁₁ is a peel force between the first housing and the first sealing material layer. This arrangement can reduce the risk of bursting the seal interface when the electrochemical device is impacted such as dropped, thereby improving the safety and reliability of the electrochemical device.

### CROSS-REFERENCE TO RELATED APPLICATIONS

This application is a continuation application of PCT International Application No. PCT/CN2022/091223, filed on May 6, 2022, the contents of which are incorporated herein by reference in its entirety.

### TECHNICAL FIELD

This application relates to the technical field of batteries, and in particular, to an electrochemical device and an electronic device.

### BACKGROUND

Currently, batteries are widely used in electronic products such as a mobile phone, a tablet, and a laptop computer. In some application scenarios, a single battery cell is unable to achieve the desired power output. Therefore, a plurality of battery cells are usually connected in series, parallel, or series-and-parallel pattern, so that the plurality of battery cells work together to achieve the desired power output. However, although the plurality of battery cells connected in series, parallel, or series-and-parallel pattern can increase the output power, the energy density of the entire battery pack is relatively low. Therefore, the design of same-package series/parallel batteries is put forward. The same-package series/parallel batteries include a housing and a plurality of electrode assemblies disposed in the same housing. The electrode assemblies in series need to be separated by a separation piece to avoid decomposition of an electrolyte solution at high voltage. The electrode assemblies in parallel are separated by a separation piece to avoid interference with each other.

### SUMMARY

An objective of this application is to provide an electrochemical device and an electronic device to improve the safety and reliability when batteries connected in series or in parallel in the same package are impacted such as dropped.

According to a first aspect, this application provides an electrochemical device. The electrochemical device includes a first housing, a second housing, a first separation piece, a first electrode assembly, and a second electrode assembly. The first separation piece is disposed between the first housing and the second housing. A first cavity and a second cavity are disposed on two sides of the first separation piece of the electrochemical device respectively. The first separation piece includes a first substrate layer and a first sealing material layer located on a surface of the first substrate layer. The first electrode assembly is disposed in the first cavity. The second electrode assembly is disposed in the second cavity. The electrochemical device satisfies: Fₛ₁₁/F₁₁≥1.2, where F₁₁ is a peel force between the first sealing material layer and the first substrate layer, and Fₛ₁₁ is a peel force between the first housing and the first sealing material layer.

The inventors of this application find through research that, for batteries connected in series/parallel in the same package, because a separation piece exists between the first housing and the second housing, a seal interface exists additionally. In addition, a plurality of electrode assemblies exist in the housing, so that the impact kinetic energy increases significantly when the electrochemical device is impacted such as dropped, thereby increasing the risk of bursting the seal interface. By making the electrochemical device satisfy Fₛ₁₁/F₁₁≥1.2, the seal interface between the housing and the separation piece possesses a stronger bonding force than the bonding interface between the sealing material layer and the substrate layer in the separation piece. When the electrochemical device is impacted such as dropped, the bonding interface between the sealing material layer and the substrate layer in the separation piece can exert a buffering effect to reduce the impact on the seal interface between the housing and the separation piece, thereby reducing the risk of bursting the seal interface, and improving the safety and reliability of the electrochemical device.

In some embodiments, the electrochemical device satisfies at least one of the following conditions: (i) F₁₁≥0.4 N/mm; (ii) Fₛ₁₁≥1 N/mm; (iii) Fₛ₁₁/F₁₁≥2.5; or (iv) Fₛ₁₁/F₁₁≤15. When F₁₁≥0.4 N, moisture can be suppressed from penetrating into the interior of the electrochemical device through the interface between the sealing material layer and the substrate layer in a high-temperature and high-humidity environment, thereby improving the resistance of the electrochemical device to high temperature and high humidity. When Fₛ₁₁≥1 N/mm, the bonding strength of the seal interface between the housing and the separation piece can be increased, thereby reducing the risk of bursting the seal interface and improving the safety and reliability of the electrochemical device. When Fₛ₁₁/F₁₁≥2.5, the relative bonding strength of the seal interface between the housing and the separation piece can be further increased, thereby reducing the risk of bursting the seal interface and improving the safety and reliability of the electrochemical device.

In some embodiments, the first separation piece further includes a second sealing material layer. The first substrate layer is located between the first sealing material layer and the second sealing material layer. The electrochemical device satisfies: 0.8≤F₁₁/F₁₂≤1.2, where F₁₂ is a peel force between the second sealing material layer and the first substrate layer. When 0.8≤F₁₁/F₁₂≤1.2, the bonding strength between the substrate layer and the sealing material layer on one side is equivalent to the bonding strength between the substrate layer and the sealing material layer on the other side, thereby alleviating the excessive concentration of impact kinetic energy on one side, dispersing the impact kinetic energy on both sides of the separation piece, and reducing the risk of detachment between the substrate layer and the sealing material layer.

In some embodiments, the first separation piece further includes a second sealing material layer. The first substrate layer is located between the first sealing material layer and the second sealing material layer. The electrochemical device satisfies: Fₛ₂₁/F₁₂≥1.2, where F₁₂ is a peel force between the second sealing material layer and the first substrate layer, and Fₛ₂₁ is a peel force between the second housing and the second sealing material layer. Similarly, when the electrochemical device is impacted such as dropped, this arrangement favorably enables the bonding interface between the sealing material layer and the substrate layer in the separation piece to exert a buffering effect to reduce the impact on the seal interface between the housing and the separation piece, thereby reducing the risk of bursting the seal interface, and improving the safety and reliability of the electrochemical device.

In some embodiments, the electrochemical device satisfies at least one of the following conditions: (i) F₁₂≥0.4 N/mm; (ii) Fₛ₂₁≥1 N/mm; (iii) Fₛ₂₁/F₁₂≥2.5; or (iv) Fₛ₂₁/F₁₂≤15.

In some embodiments, the first separation piece further includes a second sealing material layer. The first substrate layer is located between the first sealing material layer and the second sealing material layer. The electrochemical device further includes at least one second separation piece. The second separation piece includes a third sealing material layer, a fourth sealing material layer, and a second substrate layer located between the third sealing material layer and the fourth sealing material layer. The electrochemical device satisfies at least one of the following conditions: (a) Fₛₛ/F₁₂≥1.2; (b) Fₛₛ/F₂₁≥1.2; (c) Fₛ₂₂/F₂₂≥1.2; (d) Fₚₚ/F₂₁≥1.2; (e) Fₚₚ/F₂₂≥1.2; or (f) 0.8≤F₂₁/F₂₂≤1.2. Where, F₁₂ is a peel force between the second sealing material layer and the first substrate layer, F₂₁ is a peel force between the third sealing material layer and the second substrate layer, Fₛₛ is a peel force between the third sealing material layer and the second sealing material layer, F₂₂ is a peel force between the fourth sealing material layer and the second substrate layer, Fₛ₂₂ is a peel force between the fourth sealing material layer and the second housing, and Fₚₚ is a peel force between two adjacent second separation pieces.

In some embodiments, the electrochemical device satisfies at least one of the following conditions: (i) F₁₂≥0.4 N/mm; (ii) Fₛₛ≥1 N/mm; or (iii) Fₛₛ/F₁₂≥2.5. In some embodiments, the electrochemical device satisfies at least one of the following conditions: (i) F₂₁≥0.4 N/mm; (ii) Fₛₛ≥1 N/mm; or (iii) Fₛₛ/F₂₁≥2.5. In some embodiments, the electrochemical device satisfies at least one of the following conditions: (i) F₂₂≥0.4 N/mm; (ii) Fₛ₂₂≥1 N/mm; or (iii) Fₛ₂₂/F₂₂≥2.5. In some embodiments, the electrochemical device satisfies at least one of the following conditions: (i) F₂₁≥0.4 N/mm; (ii) Fₚₚ≥1 N/mm; or (iii) Fₚₚ/F₂₁≥2.5. In some embodiments, the electrochemical device satisfies at least one of the following conditions: (i) F₂₂≥0.4 N/mm; (ii) Fₚₚ≥1 N/mm; or (iii) Fₚₚ/F₂₂≥2.5.

In some embodiments, the electrochemical device satisfies at least one of the following conditions: (1) Fₛₛ/F₁₂≤15; (2) Fₛₛ/F₂₁≤15; (3) Fₛ₂₂/F₂₂≤15; (4) Fₚₚ/F₂₁≤15; or (5) Fₚₚ/F₂₂≤15.

In some embodiments, the first sealing material layer includes a first seal region, and the second sealing material layer includes a second seal region, satisfying: 0.9≤W₁/W₂≤1.1, where W₁ is a width of the first seal region, and W₂ is a width of the second seal region. In this case, the width of the first seal region is equivalent to the width of the second seal region, thereby reducing the excessive concentration of impact kinetic energy on one side, dispersing the impact kinetic energy on both sides of the separation piece, and reducing the risk of bursting the seal interface between the separation piece and the housing on one side.

In some embodiments, the first substrate layer is made of a material including metal, and the first sealing material layer and/or the second sealing material layer is made of a material including a first polymer. In some embodiments, the second substrate layer is made of a material including metal, and the third sealing material layer and/or the fourth sealing material layer is made of a material including a first polymer.

In some embodiments, the metal includes at least one of Ni, Ti, Cu, Ag, Au, Pt, Fe, Co, Cr, W, Mo, Al, Mg, K, Na, Ca, Sr, Ba, Si, Ge, Sb, Pb, In, Zn, stainless steel, or a composition or alloy thereof.

In some embodiments, the first polymer includes at least one of polypropylene, acid anhydride modified polypropylene, polyethylene, poly(ethylene-co-propylene), polyvinyl chloride, polystyrene, polyether nitrile, polyurethane, polyamide, polyester, poly(amorphous α-co-olefin), or a derivative thereof.

In some embodiments, the first housing includes a first cavity portion and a first peripheral portion. The first cavity portion is recessed away from the second housing to form a concave cavity, and the first peripheral portion surrounds the first cavity portion. The second housing includes a second cavity portion opposite to the first cavity portion and a second peripheral portion opposite to the first peripheral portion. The first seal region and the second seal region are located between the first peripheral portion and the second peripheral portion.

In some embodiments, the first electrode assembly and the second electrode assembly are connected in series.

According to a second aspect, this application further provides an electronic device. The electronic device includes the aforementioned electrochemical device.

### BRIEF DESCRIPTION OF DRAWINGS

One or more embodiments are described illustratively with reference to corresponding drawings. The illustrative description does not constitute any limitation on the embodiments. Components marked with the same reference numeral in the drawings represent similar components. Unless otherwise expressly specified, the drawings are not drawn to scale.

FIG. 1 is a schematic diagram of an electrochemical device according to an embodiment of this application;

FIG. 2 is a schematic exploded view of the electrochemical device shown in FIG. 1;

FIG. 3 is a cross-sectional schematic view of the electrochemical device 1 shown in FIG. 1 and sectioned along an A-A line;

FIG. 4 is a close-up view of a part B shown in FIG. 3;

FIG. 5 is a schematic structural diagram of a first separation piece shown in FIG. 2;

FIG. 6 is a schematic diagram of an electrochemical device according to another embodiment of this application;

FIG. 7 is a close-up view of a part C shown in FIG. 6;

FIG. 8 is a schematic structural diagram of a second separation piece shown in FIG. 7; and

FIG. 9 is a schematic diagram of an electronic device according to an embodiment of this application.

### LIST OF REFERENCE NUMERALS

1. electrochemical device;
100. first housing; 110. first cavity portion; 120. first peripheral portion; 101. first cavity; 102. second cavity;
200. second housing; 210. second cavity portion; 220. second peripheral portion;
300. first separation piece; 310. first separation portion; 320. first sealing portion; 330. first substrate layer; 340. first sealing material layer; 350. second sealing material layer;
400. first electrode assembly;
500. second electrode assembly;
600. tab module; 610. first tab; 620. second tab;
1b. electrochemical device;
100b. first housing;
200b. second housing;
300b. first separation piece;
400b. first electrode assembly;
500b. second electrode assembly;
700b. second separation piece; 710b. second separation portion; 720b. second sealing portion; 730b. second substrate layer; 740b. third sealing material layer; 750b. fourth sealing material layer;
800b. third electrode assembly;
2. electronic device.

### DETAILED DESCRIPTION

For ease of understanding this application, the following describes this application in more detail with reference to drawings and specific embodiments. It is hereby noted that an element referred to herein as being “fixed to”, “fastened to”, or “mounted to” another element may be directly disposed on the other element, or may be fixed or fastened to the other element with one or more elements in between. An element referred to herein as “connected to” another element may be connected to the other element directly or with one or more elements in between. The terms “vertical”, “horizontal”, “left”, “right”, “in”, “out” and other similar expressions used herein are merely for ease of description.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein is intended to include any and all combinations of one or more relevant items recited.

In addition, to the extent that no mutual conflict occurs, the technical features described below in different embodiments of this application may be combined with each other.

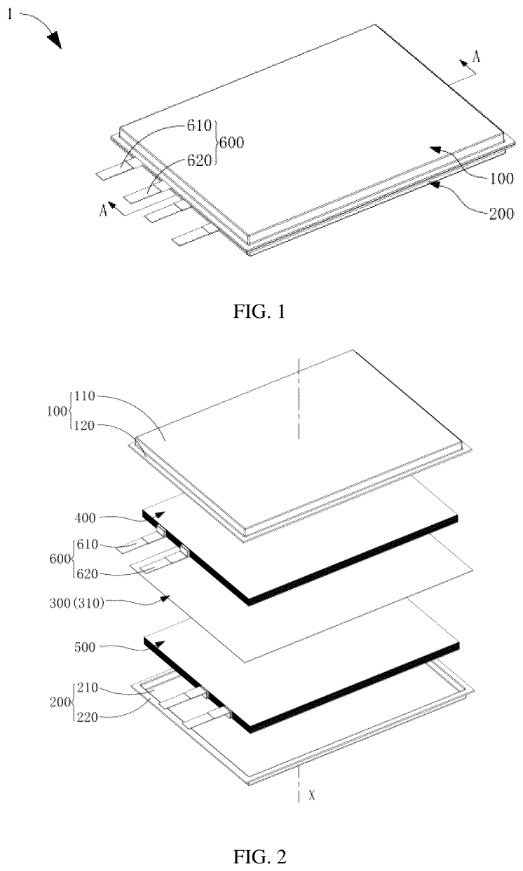

Referring to FIG. 1 to FIG. 4, which show a schematic diagram of an electrochemical device 1 according to an embodiment of this application and a schematic exploded view of the electrochemical device 1. The electrochemical device 1 includes a first housing 100, a second housing 200, a first separation piece 300, a first electrode assembly 400, and a second electrode assembly 500. The first housing 100, the first separation piece 300, and the second housing 200 are sequentially arranged along a first direction X (a thickness direction of the electrochemical device 1). The first housing 100 and the second housing 200 close in to form a shell part of the electrochemical device 1 as a whole. The first separation piece 300 is disposed between the first housing 100 and the second housing 200. A first cavity 101 and a second cavity 102 are disposed on two sides of the first separation piece 300 of the electrochemical device 1 respectively. The first separation piece 300 includes a first substrate layer and a first sealing material layer located on a surface of the first substrate layer. The first separation piece 300 is fixed to the first housing 100 through the first sealing material layer. The first electrode assembly 400 is disposed in the first cavity, and the second electrode assembly 500 is disposed in the second cavity. To better understand the specific structure of the electrochemical device 1, the following describes the specific structures of the first housing 100, the second housing 200, the first separation piece 300, the first electrode assembly 400, and the second electrode assembly 500 sequentially.

For details of the first housing 100 and second housing 200, referring to FIG. 2 together with other drawings, the first housing 100 and the second housing 200 are disposed opposite to each other along the first direction X shown in the drawing. An accommodation space is defined between the first housing and second housing. In other words, the electrochemical device 1 includes two housing parts disposed opposite to each other along the first direction X. The first housing 100 is one of the two housing parts, and the second housing 200 is the other of the two housing parts. The first housing 100 on the whole is a box-like structure, and includes a first cavity portion 110 and a first peripheral portion 120. The first cavity portion 110 is recessed away from the second housing 200 to form a concave cavity. Specifically, the first cavity portion 110 includes a first bottom wall and a first sidewall formed by extending the edge of the first bottom wall along the first direction X. The first bottom wall and the first sidewall together define the concave cavity. The concave cavity of the first cavity portion 110 is disposed toward the second housing 200. The first peripheral portion 120 assumes a thin sheet structure, and is formed by extending the open end of the first cavity portion 110 outward, and surrounds the first cavity portion 110. The second housing 200 on the whole is also a box-like structure, and includes a second cavity portion 210 opposite to the first cavity portion 110 and a second peripheral portion 220 opposite to the first peripheral portion 120. The second cavity portion 210 is recessed away from the first housing 100 to form a concave cavity. In this embodiment, the second cavity portion 210 includes a second bottom wall and a second sidewall formed by extending the edge of the second bottom wall along the first direction X. The second bottom wall and the second sidewall together define the concave cavity of the second cavity portion 210. The concave cavity of the second cavity portion 210 is disposed toward the first housing 100. The second peripheral portion 220 assumes a thin sheet structure, and is formed by extending the open end of the second cavity portion 210 outward, and surrounds the second cavity portion 210. In this embodiment, the first housing 100 and the second housing 200 are two independent structures. The concave cavities of the first cavity portion 110 and the second cavity portion 210 are separately formed by stamping. Understandably, in other embodiments of this application, the first housing 100 and the second housing 200 may be formed in one piece instead. Specifically, the same sheet-like structure is stamped to form two concave cavities and then folded to form the first housing 100 and second housing 200 disposed opposite to each other.

The materials of the first housing 100 and the second housing 200 are actually diverse. Using the first housing 100 as an example, in this embodiment, the first housing 100 includes a first insulation material layer, a first metal substrate layer, and a second insulation material layer that are stacked. Along the thickness direction of the sheet of the first housing 100, the first metal substrate layer is disposed between the first insulation material layer and the second insulation material layer. The first insulation material layer is oriented toward the first separation piece 300. The second insulation material layer is oriented away from the first separation piece 300. Optionally, the material of the metal substrate layer includes aluminum. The material of the first insulation material layer and/or the second insulation material layer includes polypropylene. Definitely, in some other embodiments of this application, adaptive changes may be made on this basis. For example, the metal substrate layer includes materials such as aluminum alloy, copper alloy; and the first insulation material layer and/or the second insulation material layer includes at least one of modified polypropylene, polyethylene, poly(ethylene-co-propylene), poly(ethylene-co-vinyl acetate), or poly(ethylene-co-ethyl acrylate). The structure and material of the second housing 200 are basically the same as those of the first housing 100, and include a third insulation material layer, a second metal substrate layer, and a fourth insulation material layer. The specific materials of the three layers may be learned by referring to the above description about the material of the first housing 100, and are not described in detail here.

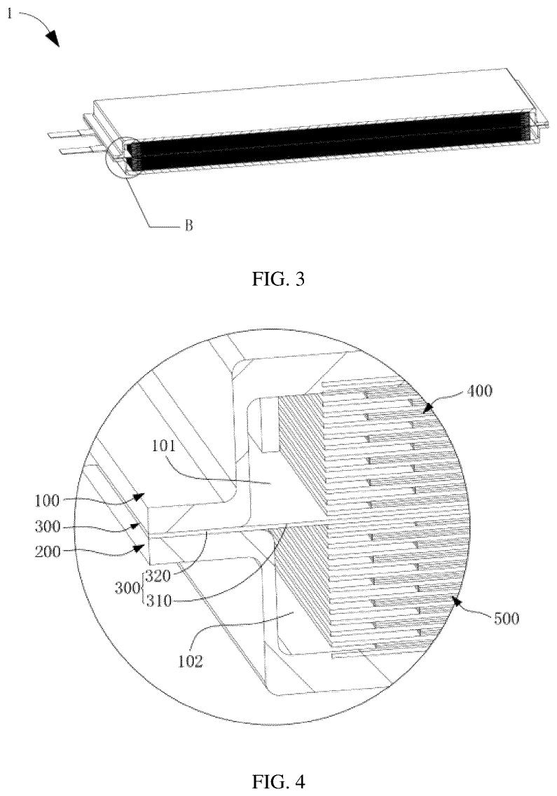

For the first separation piece 300, referring to FIG. 3 and FIG. 4, which show a cross-sectional schematic view of the electrochemical device 1 along an A-A line and a close-up view of a part B of the electrochemical device 1 respectively, and also referring to other drawings together, the first separation piece 300 is disposed between the first housing 100 and the second housing 200. In this way, the first separation piece 300 separates the accommodation space defined by the first housing 100 and the second housing 200, so as to form a first cavity 101 and a second cavity 102 located on two sides of the first separation piece 300 respectively along the first direction X. In other words, the electrochemical device 1 includes the first cavity 101 and the second cavity 102 on the two sides of the first separation piece 300 respectively. The first separation piece 300 and the first housing 100 together define the first cavity 101, and the first separation piece 300 and the second housing 200 together define the second cavity 102.

Specifically, the first separation piece 300 assumes a thin sheet structure, and includes a first separation portion 310 and a first sealing portion 320. The first separation portion 310 is flat, and is accommodated inside the accommodation space, and is located between the first electrode assembly 400 and the second electrode assembly 500, thereby separating the first electrode assembly 400 from the second electrode assembly 500. The first sealing portion 320 is formed by extending the edge of the first separation portion 310 outward, and surrounds the first separation portion 310. The first sealing portion 320 is disposed between the first peripheral portion 120 and the second peripheral portion 220, and is fixed and connected to the first peripheral portion 120 and the second peripheral portion 220 separately. Understandably, even if the first separation portion 310 is flat as a whole in this embodiment, in some other embodiments of this application, the shape of the first separation portion 310 may also be adaptively changed on the basis of the above shape, as long as it is ensured that the first separation portion is still accommodated in the accommodation space and disposed between the first electrode assembly 400 and the second electrode assembly 500 to separate the two electrode assemblies. For example, in some embodiments, the first separation portion 310 assumes a flat box-like structure, and is recessed on a side oriented toward the first housing 100 (or the second housing 200) to form a concave cavity, and the first sealing portion 320 is formed by extending the open edge of the concave cavity outward. At least a part of the first electrode assembly 400 is located in the concave cavity.

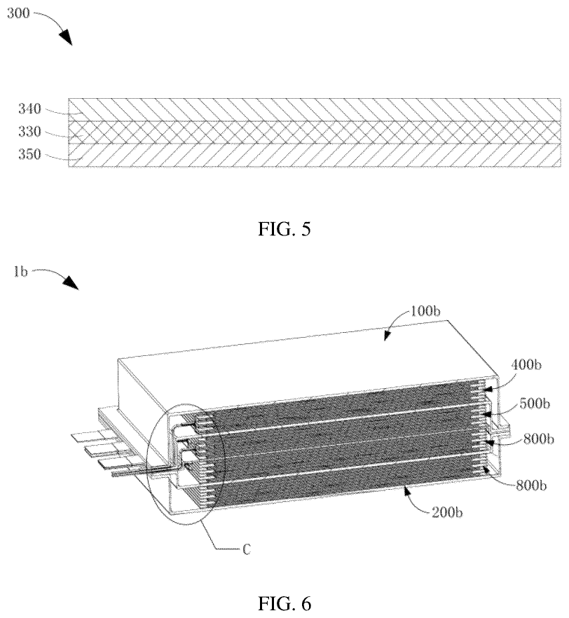

The following describes the structure of the first separation piece 300. Referring to FIG. 5, which shows a schematic diagram of the structure of the first separation piece 300, the first separation piece 300 includes a first substrate layer 330 and a first sealing material layer 340. The first substrate layer 330 assumes a sheet structure as a whole, and is a basic material layer for supporting the first sealing material layer 340. The first substrate layer 330 includes a main body region (not shown) located in the first separation portion 310 and a sealing region (not shown) located in the first sealing portion 320. In this embodiment, the material of the first substrate layer 330 includes aluminum. Specifically, the first substrate layer 330 is an aluminum foil that is 8 μm to 40 μm thick. Understandably, in some other embodiments of this application, the first substrate layer 330 may include other metal materials; or may be a thin film containing a polymer material, for example, a thin film containing a polyethylene terephthalate material. The specific material of the first substrate layer 330 is not particularly limited herein.

The first sealing material layer 340 also assumes a sheet structure as a whole, and is disposed on a surface of the first substrate layer 330, and is located on one side of the first substrate layer 330, the side being oriented toward the first housing 100. The first separation piece 300 is fixed to the first housing 100 through the first sealing material layer 340. The first sealing material layer 340 includes a first separation region (not shown) located in the first separation portion 310 and a first sealing region (not shown) located in the first sealing portion 320. In other words, the first sealing region is located between the first peripheral portion 120 and the second peripheral portion 220. The first sealing region is fixed to the first peripheral portion 120. The first sealing region includes a first seal region. Specifically, the first sealing region includes a first part and a second part disposed opposite to each other along the second direction, and a third part and a fourth part disposed opposite to each other along the third direction. The first seal region is one of the first part, the second part, the third part, or the fourth part. The second direction is a direction from a tab outstretch end of the electrochemical device 1 to an end away from the tab outstretch end. The second direction, the third direction, and the first direction X are perpendicular to each other. In this embodiment, the material of the first sealing material layer 340 includes a polymer material, and can be bonded to the surface of the first substrate layer 330 by an adhesive. The first sealing material layer 340 may be fixed to the first peripheral portion 120 by hot melting, thereby ensuring a good fixing effect between the first separation piece 300 and the first housing 100 on the one hand, and ensuring good sealing performance between the first separation piece and the first housing on the other hand.

Optionally, the material of the first sealing material layer 340 includes a first polymer. The first insulation material layer oriented toward the first separation piece 300 in the first housing 100 also includes the first polymer. In this way, when the first separation piece 300 is fixed to the first housing 100 by hot-melting, the first separation piece and the first housing can penetrate each other based on the “like dissolves like” principle, thereby improving the sealing performance between the first separation piece and the first housing. In this embodiment, the first polymer is polypropylene. Understandably, in some other embodiments of this application, the first polymer may be another polymer material such as polyethylene.

In this embodiment, the first separation piece 300 further includes a second sealing material layer 350. The second sealing material layer 350 also assumes a sheet structure as a whole, and is disposed on a surface of the first substrate layer 330, the surface being oriented away from the first sealing material layer 340. That is, the second sealing material layer is located on one side of the first substrate layer 330, the side being oriented toward the second housing 200. The first separation piece 300 is fixed to the second housing 200 through the second sealing material layer 350. The second sealing material layer 350 includes a second separation region (not shown) located in the first separation portion 310 and a second sealing region (not shown) located in the first sealing portion 320. In other words, the second sealing region is located between the second peripheral portion 220 and the first peripheral portion 120. The second sealing region is fixed to the second peripheral portion 220. The second sealing region includes a second seal region disposed opposite to the first seal region. Specifically, the second sealing region includes a fifth part and a sixth part disposed opposite to each other along the second direction, and a seventh part and an eighth part disposed opposite to each other along the third direction. The second seal region is one of the fifth part, the sixth part, the seventh part, or the eighth part. The second seal region corresponds to the first seal region. In this embodiment, the material of the second sealing material layer 350 includes a polymer material. The second sealing material layer is fixed to the second peripheral portion 220 by hot melting, thereby ensuring a good fixing effect between the first separation piece 300 and the second housing 200 on the one hand, and ensuring good sealing performance between the first separation piece and the second housing on the other hand. Optionally, the material of the second sealing material layer 350 includes a first polymer. The insulation material layer oriented toward the first separation piece 300 in the second housing 200 also includes the first polymer. In this way, when the first separation piece 300 is fixed to the second housing 200 by hot-melting, the first separation piece and the second housing can penetrate each other based on the “like dissolves like” principle, thereby improving the sealing performance between the first separation piece and the second housing. In this embodiment, the first polymer is polypropylene. Understandably, in some other embodiments of this application, the first polymer may be another polymer material such as polyethylene.

It is worth mentioning that the peel force F₁₁ between the first substrate layer 330 and the first sealing material layer 340 (first bonding region) in comparison with the peel force Fₛ₁₁ between the first sealing material layer 340 and the first housing 100 (second bonding region) affects the anti-drop performance of the second bonding region exhibited when the electrochemical device 1 is impacted (such as accidentally dropped). The following describes the impact of the peel force F₁₁ of the first bonding region and the peel force Fₛ₁₁ of the second bonding region on the performance of the electrochemical device with reference to the experimental data in Table 1. First of all, in order to better understand the experimental data in Table 1, the concepts involved in Table 1 are explained below.

The “peel force” mentioned in this application means a maximum force required to peel off two mutually fixed components from a contact interface or contact region (such as the bonding region) per unit width. For example, 2 N/mm means that, when the width of the bonding region between the two components is 1 mm, the maximum force required to separate the two components along a direction perpendicular to the width direction of the bonding region is 2N. A specific measurement method is as follows: taking a bonding region specimen with a width of W₁ (for example, W₁ may be 15 mm), using a multi-functional tensile tester, letting the grippers grip the materials on both sides of the bonding region, setting the tensile speed to 50 mm/min, testing the tensile force to obtain a maximum tensile force P₁, and calculating the peel force as: F=P₁/W₁.

The method of “high-temperature and high-humidity test” mentioned in this application includes the following steps S101 to S105. S101: First, charging an electrochemical device 1 at a constant current of 1C until the voltage reaches 4.2 V, and then charging the electrochemical device at a constant voltage of 4.2 V until a cut-off current of 10 mA. S102: Leaving the electrochemical device 1 to stand in a constant-temperature and constant-humidity chamber at 65° C.±2° C. and relative humidity 90% to 95% for 48 hours. S103: Taking out the electrochemical device 1 and leaving the electrochemical device to stand in a 25±2° C. environment for 2 hours, and observing whether the electrochemical device 1 is deformed or leaking. S104: If the electrochemical device is not deformed or leaking, discharging the electrochemical device at a constant current of 1C until the voltage drops to 2.75 V, recording the discharge capacity at this time as an initial capacity, thereby completing one cycle. Repeating the above charging and discharging steps for 3 cycles at 25° C.±2° C., recording the discharge capacity at the end of the 3^{rd} cycle, and calculating the capacity retention rate as: capacity retention rate=3^{rd}-cycle discharge capacity/initial capacity×100%. S105: Determining whether the electrochemical device 1 passes the test. If the electrochemical device 1 is not deformed or leaking and the capacity retention rate is greater than or equal to 85%, the electrochemical device passes the test; otherwise, the electrochemical device fails the test.

The “drop test” mentioned in this application includes the following steps S201 to S203. S201: At an ambient temperature of 25±2° C., lifting the electrochemical device 1 to a height of 1.2 m from the work surface or the ground, and then releasing the electrochemical device 1 so that the electrochemical device 1 falls freely onto the work surface or the ground. S202: Repeating the above step S201 for preset 20 times. S203: Checking whether there are cracks between the first housing 100 and the first sealing material layer 340 (the second bonding region) of the electrochemical device 1, and checking whether there are cracks between the first sealing material layer 340 and the first substrate layer 330 (the first bonding region). If there are no cracks, the electrochemical device 1 passes the test; if there are any cracks, the electrochemical device 1 fails the test. Taking 10 electrochemical devices 1 as specimens and performing the above test steps on the specimens, recording the number of specimens that pass the test, and calculating the pass rate of the drop test as: pass rate=the number of passes/10.

### Embodiment 1

### Preparing a Lithium-Ion Battery

(1) Preparing a negative electrode plate: Mixing artificial graphite as a negative active material, conductive carbon black (Super P), and the styrene butadiene rubber (SBR) at a weight ratio of 96:1.5:2.5, adding deionized water, blending the mixture into a slurry with a solid content of 70 wt %, and stirring the slurry evenly. Coating the slurry evenly on one surface of a negative current collector copper foil, and drying the current collector to obtain a negative electrode plate coated with a negative active material layer on a single side. Repeating the above steps on the other surface of the negative current collector copper foil to obtain a negative electrode plate coated with the negative active material layer on both sides. Performing cold-pressing, and cutting the negative electrode plate into 41 mm×61 mm sheets for future use.
(2) Preparing a positive electrode plate: Mixing lithium cobalt oxide (LiCoO₂) as a positive active material, conductive carbon black (super P), and polyvinylidene difluoride (PVDF) at a weight ratio of 97.5:1.0:1.5, adding N-methyl pyrrolidone (NMP), blending the mixture into a slurry with a solid content of 75 wt %, and stirring the slurry evenly. Coating the slurry evenly on one surface of a positive current collector aluminum foil, and drying the current collector to obtain a positive electrode plate coated with a positive active material layer on a single side. Repeating the foregoing steps on the other surface of the positive current collector aluminum foil to obtain a positive electrode plate of which both sides are coated with the positive active material layer. Performing cold-pressing, and then cutting the positive electrode plate into 38 mm×58 mm sheets for future use.
(3) Preparing an electrolyte solution: Mixing ethylene carbonate (EC), ethyl methyl carbonate (EMC), and diethyl carbonate (DEC) at a weight ratio of EC:EMC:DEC=30:50:20 in a dry argon atmosphere to form an organic solvent, then adding lithium salt hexafluorophosphate (LiPF₆) into the organic solvent to dissolve, and stirring evenly to obtain an electrolyte solution in which the concentration of LiPF₆ is 12.5% based on the mass of the electrolyte solution.
(4) Preparing a first electrode assembly and a second electrode assembly: Stacking the separator, the negative electrode plate, the separator, and the positive electrode plate in sequence to form a stacked structure, and then fixing the four corners of the entire stacked structure to obtain an electrode plate assembly. Each electrode assembly includes a positive tab and a negative tab. The positive tab is made of aluminum (Al), the negative tab is made of nickel (Ni), and the two tabs are disposed in parallel. The separator is a 15 μm-thick polyethylene (PE) film.
(5) Preparing the separation piece: Using an applicator to apply maleic-anhydride-grafted and modified polypropylene glue onto one surface of a 30 μm-thick aluminum layer. Compounding the polypropylene glue with a 25 μm-thick polypropylene film, where the glue layer is 1 μm thick, so that the glue layer and the polypropylene film together constitute a sealing material layer. Repeating the above process on the other surface of the aluminum layer to complete preparing the separation piece.
(6) Assembling the electrode assembly: Putting a punch-molded aluminum plastic film (150 μm thick) into an assembly jig, with the pit side upward. Putting the first electrode assembly into the pit. Applying a tab adhesive to a region corresponding to the tabs of the first electrode assembly and located at the edge of the aluminum plastic film. Subsequently, placing the separation piece onto the first electrode assembly to align the edges, and applying an external force to compact to obtain a semi-finished assembled product. Placing the semi-finished assembled product into an assembly jig, with one side of the separation piece facing upward, placing the second electrode assembly onto the separation piece to align the edges, and applying an external force to compact. Subsequently, overlaying the second electrode assembly with another punch-molded aluminum plastic film, with the pit side downward, and applying a tab adhesive onto a region corresponding to the tabs of the second electrode assembly and located at the edge of the aluminum plastic film. Leading the positive and negative tabs of the first electrode assembly and the second electrode assembly out of the aluminum plastic film, and performing top sealing and side sealing through heat sealing to obtain an assembled electrode assembly. During heat sealing, the fusion rate between the sealing material layer of the separation piece and the PP layer on the inner side of the aluminum plastic film is 50%. Fusion rate=distance between the aluminum layer in the heat-sealed aluminum plastic film and the substrate layer in the separation piece/(thickness of the single-side sealing material layer in the separation piece before heat sealing+thickness of the PP layer on the inner side of the aluminum plastic film before heat sealing). The ratio of the width of the seal region on one side of the separation piece to the width of the seal region on the other side of the separation piece, denoted as W₁/W₂, is 1.
(7) Electrolyte injection and sealing: Injecting an electrolyte solution into each cavity separately, and then performing hot-pressing, chemical formation, degassing, and sealing.
(8) Series connection: Welding the negative tab of the first electrode assembly to the positive tab of the second electrode assembly together by laser welding to implement a series connection and complete the assembling of the lithium-ion battery.

Embodiment 2 differs from Embodiment 1 in that in the preparation step of the separation piece, the thickness of the glue layer is 2 μm; in the assembling step of the electrode assembly, during heat sealing, the fusion rate between the sealing material layer of the separation piece and the PP layer on the inner side of the aluminum plastic film is 56%.

Embodiment 3 differs from Embodiment 2 in that in the assembling step of the electrode assembly, during heat sealing, the fusion rate between the sealing material layer of the separation piece and the PP layer on the inner side of the aluminum plastic film is 70%.

Embodiment 4 differs from Embodiment 2 in that in the preparation step of the separation piece, the thickness of the glue layer is 5 μm; in the assembling step of the electrode assembly, during heat sealing, the fusion rate between the sealing material layer of the separation piece and the PP layer on the inner side of the aluminum plastic film is 82%.

Embodiments 5 to 11 differ from Embodiment 4 in that in the assembling step of the electrode assembly, during heat sealing, the fusion rate between the sealing material layer of the separation piece and the PP layer on the inner side of the aluminum plastic film is 78%, 60%, 75%, 63%, 73%, 65%, 68%, respectively.

Comparative Embodiments 1 to 2 differ from Embodiment 4 in that in the assembling step of the electrode assembly, during heat sealing, the fusion rate between the sealing material layer of the separation piece and the PP layer on the inner side of the aluminum plastic film is 50% and 54%, respectively.

Table 1 shows F₁₁, Fₛ₁₁, and the corresponding high-temperature and high-humidity test and drop test results of the lithium-ion batteries obtained in Embodiments 1 to 11 and Comparative Embodiments 1 to 2.

Specifically, as can be seen from Comparative Embodiments 1 to 2 and Embodiments 1 to 11, when Fₛ₁₁/F₁₁ is less than 1.2, the pass rate of the drop test on the second bonding region of the electrochemical device 1 is less than 5/10, and the safety is relatively low. When Fₛ₁₁/F₁₁ is greater than or equal to 1.2, especially when Fₛ₁₁/F₁₁ is greater than or equal to 2.5, the pass rate of the drop test on the second bonding region of the electrochemical device 1 is increased significantly. A possible reason is that, by making the electrochemical device satisfy Fₛ₁₁/F₁₁≥1.2, the seal interface between the housing and the separation piece possesses a stronger bonding force than the bonding interface between the sealing material layer and the substrate layer in the separation piece. When the electrochemical device is impacted such as dropped, the bonding interface between the sealing material layer and the substrate layer in the separation piece can exert a buffering effect to reduce the impact on the seal interface between the housing and the separation piece, thereby reducing the risk of bursting the seal interface, and improving the safety and reliability of the electrochemical device.

Further, as can be seen from Embodiment 1 and Embodiments 2 to 11, when F₁₁≤0.4 N/mm, the high-temperature and high-humidity test pass rate of the electrochemical device 1 is less than 5/10, the sealing performance of the first bonding region is relatively low, the electrochemical device 1 is at relatively high risk of electrolyte leakage and permeation of moisture in the air under in high-temperature and high-humidity conditions, and the reliability of the electrochemical device 1 is relatively low. When F₁₁≥≥0.4 N, the high-temperature and high-humidity test pass rate of the electrochemical device 1 is increased significantly, and the sealing performance of the first bonding region is relatively high. Therefore, the setting of F₁₁≥0.4 N/mm is conducive to improving the resistance of the electrochemical device 1 to high temperature and high humidity.

Similarly, the peel force F₁₂ between the first substrate layer 330 and the second sealing material layer 350 (third bonding region) in comparison with the peel force Fₛ₂₁ between the second sealing material layer 350 and the second housing 200 (fourth bonding region) affects the anti-drop performance of the fourth bonding region exhibited when the electrochemical device 1 is impacted (such as accidentally dropped).

The above experiment is conducted based on the relationship between the peel force F₁₁ of the first bonding region and the peel force Fₛ₁₁ of the second bonding region. Understandably, the relationship between the third bonding region and the fourth bonding region is similarly symmetrical to the relationship between the first bonding region and the second bonding region, the third bonding region and the fourth bonding region also follow the above rule. Therefore, the electrochemical device further satisfies at least one of the following conditions: (i) Fₛ₂₁/F₁₂≥≥1.2; (ii) F₁₂≥≥0.4 N/mm;

$$( iii ) {F}_{s 21} \geq 1 N / mm ; or$$

$$( iv ) {F}_{s 21} / {F}_{12} \leq 15 .$$

TABLE 1
How the peel force F₁₁ of the first bonding region and the peel force F₁₂ of
the second bonding region affect the performance of the electrochemical device

| | | | | High-temperature and high- | Pass rate of drop test on | Pass rate of drop test on |
|---|---|---|---|---|---|---|
| | | | | humidity test pass rate | first bonding region | second bonding region |
| | F₁₁ | Fₛ₁₁ | Fₛ₁₁/ | Number of passes/number | Number of passes/number | Number of passes/number |
| Serial number | (N/mm) | (N/mm) | F₁₁ | of specimens tested | of specimens tested | of specimens tested |
| Embodiment 1 | 0.2 | 1 | 5 | 2/10 | 6/10 | 10/10 |
| Embodiment 2 | 0.4 | 1.8 | 4.5 | 6/10 | 7/10 | 10/10 |
| Embodiment 3 | 0.4 | 6 | 15 | 7/10 | 7/10 | 10/10 |
| Embodiment 4 | 1.8 | 2.16 | 1.2 | 9/10 | 10/10 | 5/10 |
| Embodiment 5 | 1.8 | 2.52 | 1.4 | 9/10 | 10/10 | 6/10 |
| Embodiment 6 | 1.8 | 3.24 | 1.8 | 9/10 | 10/10 | 8/10 |
| Embodiment 7 | 1.8 | 3.6 | 2.0 | 9/10 | 10/10 | 9/10 |
| Embodiment 8 | 1.8 | 3.96 | 2.2 | 9/10 | 10/10 | 9/10 |
| Embodiment 9 | 1.8 | 4.5 | 2.5 | 10/10 | 10/10 | 10/10 |
| Embodiment 10 | 1.8 | 5.04 | 2.8 | 10/10 | 10/10 | 10/10 |
| Embodiment 11 | 1.8 | 5.4 | 3.0 | 10/10 | 10/10 | 10/10 |
| Comparative | 1.8 | 1.08 | 0.6 | 8/10 | 10/10 | 0/10 |
| Embodiment 1 | | | | | | |
| Comparative | 1.8 | 1.62 | 0.9 | 8/10 | 10/10 | 3/10 |
| Embodiment 2 | | | | | | |

During the implementation of the electrochemical device 1 provided in this application, the inventors hereof further find that, when the difference between the peel force F₁₁ of the first bonding region and the peel force F₁₂ of the third bonding region is excessive, during dropping of the electrochemical device 1, the impact force will be concentrated on a side of the first substrate layer 330, the side on which the peel force is relatively small, thereby making it easier for cracks to occur between the first substrate layer 330 and the sealing material layer on this side.

Embodiment 12 differs from Embodiment 9 in that the thickness of the glue layer on the other side is 7 μm.

Embodiment 13 differs from Embodiment 9 in that the thickness of the glue layer on the other side is 6 μm.

Embodiment 14 differs from Embodiment 9 in that the thickness of the glue layer on the other side is 5.4 μm.

Table 2 shows how the relative relationship between the peel force F₁₁ of the first bonding region and the peel force of the third bonding region F₁₂ affects the performance of the electrochemical device 1. Referring to Embodiments 12 to 14, the difference between the embodiments lies in only the peel force F₁₂ of the third bonding region, that is, lies in the Fin/F₁₂ ratio.

As can be seen from Embodiment 9 and Embodiments 12 to 14, when F₁₁/F₁₂≤0.8, the pass rate of the electrochemical device 1 in the drop test of the first bonding region is less than 5/10, that is, the anti-drop performance of this side of the separation piece is relatively low. When 0.8≤F₁₁/F₁₂≤1, the pass rate of the electrochemical device 1 in the drop test of the first bonding region is increased significantly. That is, the electrochemical device 1 exhibits relatively high anti-drop performance. In view of symmetry, this means that the setting of 0.8≤F₁₁/F₁₂≤1.2 is conducive to ensuring that the first separation piece 300 exhibits relatively high anti-drop performance.

TABLE 2
How the peel force F₁₁ of the first bonding region and the peel force F₁₂ of
the third bonding region affect the performance of the electrochemical device 1

| | | | | | | Pass rate of drop test on | Pass rate of drop test on |
|---|---|---|---|---|---|---|---|
| | | | | | | second bonding region | first bonding region |
| | F₁₁ | F₁₂ | F₁₁/ | Fₛ₁₁ | Fₛ₁₁/ | Number of passes/number | Number of passes/number |
| Serial number | (N/mm) | (N/mm) | F₁₂ | (N/mm) | F₁₁ | of specimens tested | of specimens tested |
| Embodiment 12 | 1.8 | 3 | 0.6 | 4.5 | 2.5 | 10/10 | 3/10 |
| Embodiment 13 | 1.8 | 2.3 | 0.8 | 4.5 | 2.5 | 10/10 | 6/10 |
| Embodiment 14 | 1.8 | 2.0 | 0.9 | 4.5 | 2.5 | 10/10 | 10/10 |
| Embodiment 9 | 1.8 | 1.8 | 1.0 | 4.5 | 2.5 | 10/10 | 10/10 |

In the process of sealing the first housing 100, the first separation piece 300, and the second housing 200, the sealing head of the heat sealing machine is gripped on the surface of the first peripheral portion 120 and the second peripheral portion 220. By adjusting the relative width of the heat sealing head between two sides, the width of the first seal region can be made different from the width of the second seal region. The “width of the first seal region” mentioned in this application means a distance between the inner edge and the outer edge of the first seal region, that is, a distance between the edge, close to the inner cavity of the housing 100, of the first seal region and the edge, away from the inner cavity of the housing 100, of the first seal region. Similarly, the “width of the second seal region” mentioned in this application means a distance between the inner edge and the outer edge of the second seal region, that is, a distance between the edge, close to the inner cavity of the housing 100, of the second seal region and the edge, away from the inner cavity of the housing 100, of the second seal region.

With reference to experimental data, the following further describes how the relative relationship between the width W₁ of the first seal region and the width W₂ of the second seal region affect the anti-drop performance of the electrochemical device 1.

Embodiments 15 to 17 differ from Embodiment 9 in that the ratio of the width of the seal region on one side of the separation piece to the width of the seal region on the other side of the separation piece, denoted as W₁/W₂, is 0.8, 0.9, and 0.95, respectively.

Referring to Table 3, as can be seen from Embodiment 9 and Embodiments 15 to 17, when 0.9≤W₁/W₂≤1, the pass rate in the drop test of the second bonding region without cracking is increased significantly. At this time, the anti-drop performance of the electrochemical device 1 is relatively high. In view of symmetry, this means that the setting of 0.9≤W₁/W₂≤1.1 is conducive to ensuring that the electrochemical device 1 exhibits relatively high anti-drop performance.

TABLE 3
How the relative relationship between the width W₁ of the first
seal region and the width W₂ of the second seal region affect the
performance of the electrochemical device 1 (To be continued)

| | F₁₁ | | Fₛ₁₁ | | |
|---|---|---|---|---|---|
| Serial number | (N/mm) | F₁₁/F₁₂ | (N/mm) | Fₛ₁₁/F₁₁ | W₁/W₂ |
| Embodiment 15 | 1.8 | 1 | 4.5 | 2.5 | 0.8 |
| Embodiment 16 | 1.8 | 1 | 4.5 | 2.5 | 0.9 |
| Embodiment 17 | 1.8 | 1 | 4.5 | 2.5 | 0.95 |
| Embodiment 9 | 1.8 | 1 | 4.5 | 2.5 | 1 |

TABLE 3
How the relative relationship between the width W₁ of the first
seal region and the width W₂ of the second seal region affect
the performance of the electrochemical device 1 (Continued)

| | Pass rate of drop | Pass rate of drop |
|---|---|---|
| | test on first bonding | test on second bonding |
| | region Number of | region Number of |
| | passes/number of | passes/number of |
| Serial number | specimens tested | specimens tested |
| Embodiment 15 | 10/10 | 6/10 |
| Embodiment 16 | 10/10 | 8/10 |
| Embodiment 17 | 10/10 | 10/10 |
| Embodiment 9 | 10/10 | 10/10 |

For the first electrode assembly 400 and the second electrode assembly 500, still referring to FIG. 2 and also referring to other drawings, the first electrode assembly 400 is accommodated in the first cavity 101, and the second electrode assembly 500 is accommodated in the second cavity 102, both being core components in the electrochemical device 1. The first electrode assembly 400 includes a first electrode plate, a second electrode plate, and a separator stacked together, where the separator is disposed between the first electrode plate and the second electrode plate. Of the first electrode plate and the second electrode plate, one is a positive electrode plate, and the other is a negative electrode plate. The separator is disposed between the first electrode plate and the second electrode plate to avoid electrical contact between the first electrode plate and the second electrode plate. In this embodiment, the first electrode assembly 400 is a jelly-roll structure, and is wound into a flat shape on the whole, so as to make it convenient for the first electrode assembly to be accommodated in the first cavity 101. Understandably, in some other embodiments of this application, the first electrode assembly 400 may be a stacked structure instead, that is, stacked along a preset direction, for example, stacked along the thickness direction, and a separator is disposed between adjacent first and second electrode plates. The structure of the second electrode assembly 500 is substantially the same as that of the first electrode assembly 400, and is not described herein again.

In addition, the electrochemical device further includes a plurality of tab modules 600. The first electrode assembly 400 and the second electrode assembly 500 each are connected to at least one tab module 600 correspondingly. The tab module 600 includes a first tab 610 and a second tab 620. In the tab module 600 connected to the first electrode assembly 400, one end of the first tab 610 is connected to the first electrode plate of the first electrode assembly 400, and the other end of the first tab extends out of the shell part through the hot-melt region between the first housing 100 and the first separation piece 300. One end of the second tab 620 is connected to the second electrode plate of the first electrode assembly 400, and the other end of the second tab extends out of the shell part through the hot-melt region between the first housing 100 and the first separation piece 300. The connection relationship between the second electrode assembly 500 and the tab module 600 is substantially the same as the connection relationship between the first electrode assembly 400 and the tab module. Specifically, in the tab module 600 connected to the second electrode assembly 500, one end of the first tab 610 is connected to the first electrode plate of the second electrode assembly 500, and the other end of the first tab extends out of the shell part through the hot-melt region between the second housing 200 and the first separation piece 300. One end of the second tab 620 is connected to the second electrode plate of the second electrode assembly 500, and the other end of the second tab extends out of the shell part through the hot-melt region between the second housing and the first separation piece 300. The second tab connected to the first electrode assembly 400 is electrically connected to the first tab connected to the second electrode assembly, so as to implement a series connection between the first electrode assembly 400 and the second electrode assembly 500. Understandably, in some other embodiments of this application, the first electrode assembly 400 may be connected to the second electrode assembly 500 in parallel. In this case, the first tab connected to the first electrode assembly 400 is electrically connected to the first tab connected to the second electrode assembly 500, and the second tab connected to the first electrode assembly 400 is electrically connected to the second tab connected to the second electrode assembly 500.

For the electrochemical device, it is worth noting that even though the above embodiment illustrates the electrochemical device 1 of this application by using an example in which the electrochemical device 1 includes a first separation piece 300, a first electrode assembly 400, and a second electrode assembly 500, this application is not limited to the example.

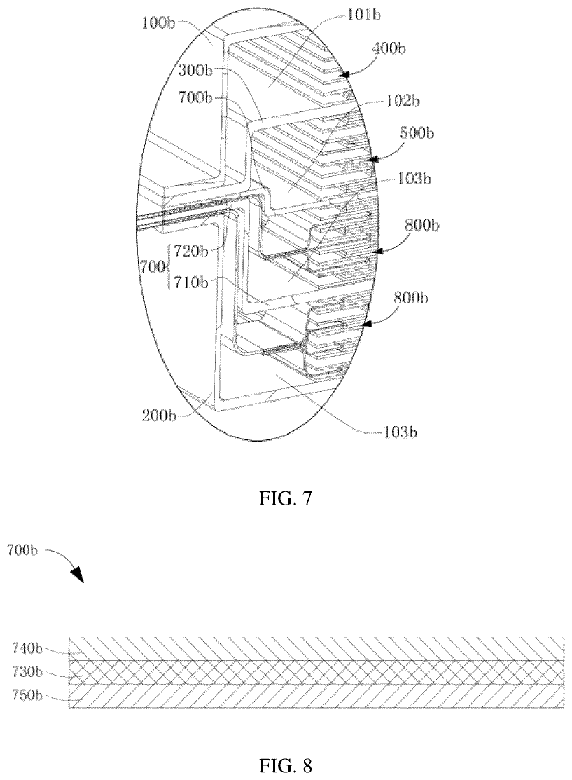

FIG. 6 and FIG. 7 show a cross-sectional schematic view of an electrochemical device 1b according to another embodiment of this application, and a close-up view of a part C, respectively. The electrochemical device 1b still includes a first housing 100b, a second housing 200b, a first separation piece 300b, a first electrode assembly 400b, and a second electrode assembly 500b. The main difference between this electrochemical device and the electrochemical device 1 in the preceding embodiment is that the electrochemical device 1b further includes at least two second separation pieces 700b and at least two third electrode assemblies 800b. The first separation piece 300b is located between the first housing 100b and the second housing 200b. The second separation piece 700b is located between the first separation piece 300b and the second housing 200b. The first housing 100b, the first separation piece 300b, each second separation piece 700b, and the second housing 200b are arranged in sequence. In this way, the electrochemical device 1 includes a first cavity 101b between the first housing 100b and the first separation piece 300b; the electrochemical device 1 includes a second cavity 102b between the first separation piece 300b and the second separation piece 700b; and the electrochemical device 1 includes a third cavity 103b between two adjacent second separation pieces 700b and between the second separation piece 700b and the second housing 200b. The first electrode assembly 400b is disposed in the first cavity 101b, the second electrode assembly 500b is disposed in the second cavity 102b, and the third electrode assembly 800b is disposed in the third cavity 103b.

The first housing 100b, the second housing 200b, the first separation piece 300b, the first electrode assembly 400b, and the second electrode assembly 500b are all structurally identical to the counterpart components in the electrochemical device 1, details of which are omitted here. The following describes the shape and structure of the second separation piece 700b.

Referring to FIG. 7, the second separation piece 700b includes a second separation portion 710b and a second sealing portion 720b. The second separation portion 710b is a flat box-like structure, and is recessed toward the first housing 100b to form a concave cavity. The second sealing portion 720b is formed by extending the edge of the open edge of the concave cavity outward, and is located between the first peripheral portion and the second peripheral portion. In this way, the electrochemical device 1b includes a third cavity 103b on a side of each second separation piece 700b, the side being oriented toward the second housing 200b. The third cavity is configured to accommodate the third electrode assembly 800b.

Referring to FIG. 8, which shows a schematic structural diagram of the second separation piece 700b, and also referring to other drawings, the structure of the second separation piece 700b is similar to that of the first separation piece 300b, and includes a third sealing material layer 740b, a fourth sealing material layer 750b, and a second substrate layer 730b located between the third sealing material layer 740b and the fourth sealing material layer 750b. The second substrate layer 730b is a basic material layer that carries the third sealing material layer 740b and the fourth sealing material layer 750b. The material of the second substrate layer may be selected with reference to the above description about the material of the first substrate layer 330, the details of which are omitted here. The third sealing material layer 740b is disposed on a side of the second substrate layer 730b, the side being oriented toward the first separation piece 300b. The material of the third sealing material layer may be selected with reference to the above description about the material of the first sealing material layer, the details of which are omitted here. The third sealing material layer 740b is fixed to the second sealing material layer by hot-melting. The fourth sealing material layer 750b is disposed on a side of the second substrate layer 730b, the side being oriented toward the second housing 200b. The material of the fourth sealing material layer may be selected with reference to the above description about the material of the second sealing material layer, the details of which are omitted here. The fourth sealing material layer is fixed to the second housing 200b by hot-melting.

In some embodiments, the electrochemical device 1 satisfies: 1.2≤Fₛₛ/F₁₂≤15, where Fₛₛ is a peel force between the third sealing material layer and the second sealing material layer. The third sealing material layer 740b is fixed to the second sealing material layer by hot-melting, so that the connection manner between the second separation piece 700b and the first separation piece 300b is equivalent to the connection manner between the second housing 200 and the first separation piece 300 in the preceding embodiment. Therefore, the setting of 1.2≤Fₛₛ/F₁₂≤15 is conducive to ensuring that relatively high anti-drop performance is exhibited between the second separation piece 700b and the first separation piece 300b.

In some embodiments, the electrochemical device 1 satisfies: 1.2≤Fₛₛ/F₂₁≤15, where Fₛₛ is a peel force between the third sealing material layer and the second sealing material layer, and F₂₁ is a peel force between the third sealing material layer and the second substrate layer. The third sealing material layer 740b is fixed to the second sealing material layer by hot-melting, and the third sealing material layer 740b is fixed to the second substrate layer 730b by bonding. In other words, the connection manner between the second separation piece 700b and the first separation piece 300b is equivalent to the connection manner between the first separation piece 300 and the first housing 100 in the preceding embodiment. Therefore, the setting of 1.2≤Fₛₛ/F₂₁≤15 is conducive to ensuring that relatively high anti-drop performance is exhibited between the second separation piece 700b and the first separation piece 300b.

In some embodiments, the electrochemical device 1 satisfies: 1.2≤Fₛ₂₂/F₂₂≤15, where Fₛ₂₂ is a peel force between the fourth sealing material layer and the second housing 200b, and F₂₂ is a peel force between the fourth sealing material layer and the second substrate layer. The fourth sealing material layer 750b is fixed to the second housing 200b by hot-melting, and the fourth sealing material layer 750b is fixed to the second substrate layer 730b by bonding, so that the connection manner between the second separation piece 700b and the second housing 200b is equivalent to the connection manner between the first separation piece 300 and the second housing 200 in the preceding embodiment. Therefore, the setting of 1.2≤Fₛₛ/F₂₂≤15 is conducive to ensuring that relatively high anti-drop performance is exhibited between the second separation piece 700b and the second housing 200b.

In some embodiments, the electrochemical device 1 satisfies: 1.2≤Fₚₚ/F₂₁≤15, where Fₚₚ is a peel force between two adjacent second separation pieces 700b, and F₂₁ is a peel force between the third sealing material layer 740b and the second substrate layer 730b. The two adjacent second separation pieces 700b are fixed together by hot-melting, the fourth sealing material layer 750b of one second separation piece 700b is fixed to the third sealing material layer 740b of the other second separation piece 700b by hot-melting, and the third sealing material layer 740b is fixed to the second substrate layer 740 by bonding. In other words, the connection manner between the two adjacent second separation pieces 700b is equivalent to the connection manner between the first housing 100 and the first separation piece 300 in the preceding embodiment. Therefore, the setting of 1.2≤Fₚₚ/F₂₁≤15 is conducive to ensuring that relatively high anti-drop performance is exhibited between the two adjacent second separation pieces 700b.

In some embodiments, the electrochemical device 1 satisfies 1.2≤Fₚₚ/F₂₂≤15, where Fₚₚ is a peel force between two adjacent second separation pieces, and F₂₂ is a peel force between the fourth sealing material layer 750b and the second substrate layer 730b. The two adjacent second separation pieces 700b are fixed together by hot-melting, the fourth sealing material layer 750b of one second separation piece 700b is fixed to the third sealing material layer 740b of the other second separation piece 700b by hot-melting, and the fourth sealing material layer 750b is fixed to the second substrate layer 730b by bonding. In other words, the connection manner between the two adjacent second separation pieces 700b is equivalent to the connection manner between the first separation piece 300 and the second housing 200 in the preceding embodiment. Therefore, the setting of 1.2≤Fₚₚ/F₂₂≤15 is conducive to ensuring that relatively high anti-drop performance is exhibited between the two adjacent second separation pieces 700b.

It is worth noting that even though the electrochemical device 1b in this embodiment includes at least two second separation pieces 700b, in some other embodiments of this application, the electrochemical device 1b may include only one second separation piece 700b instead. The number of the second separation pieces 700b included in the electrochemical device is not particularly limited herein.

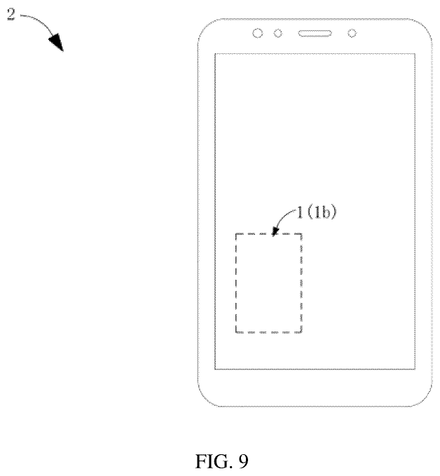

Based on the same inventive concept, another embodiment of this application further provides an electronic device 2. Specifically, referring to FIG. 9, which shows a schematic diagram of the electronic device 2, also referring to FIG. 1 to FIG. 8, the electronic device 2 includes the electrochemical device 1 (or 1b) described in any one of the above embodiments. In this embodiment, the electronic device is a mobile phone. Understandably, in some other embodiments of this application, the electronic device may be a tablet, a computer, an unmanned aerial vehicle, a remote controller, an electric vehicle, or any other electronic devices.

Finally, it is hereby noted that the foregoing embodiments are merely intended to describe the technical solutions of this application but not to limit this application. Based on the concept of this application, the technical features in the foregoing embodiments or different embodiments may be combined, the steps may be implemented in any order, and many variations may be made to this application in different aspects, which, for brevity, are not provided in detail. Although this application has been described in detail with reference to the foregoing embodiments, a person of ordinary skill in the art understands that modifications may still be made to the technical solutions described in the foregoing embodiments, or equivalent replacements may still be made to some technical features in the technical solutions. Such modifications and replacements do not make the essence of the corresponding technical solutions depart from the scope of the technical solutions of the embodiments of this application.

What is claimed is:

1. An electrochemical device, comprising:
a first housing;
a second housing;
a first separation piece, wherein the first separation piece is disposed between the first housing and the second housing; a first cavity and a second cavity are disposed on two sides of the first separation piece of the electrochemical device respectively; and
the first separation piece comprises a first substrate layer and a first sealing material layer located on a surface of the first substrate layer;
a first electrode assembly, disposed in the first cavity; and
a second electrode assembly, disposed in the second cavity; wherein
Fₛ₁₁/F₁₁≥1.2, wherein F₁₁ is a peel force between the first sealing material layer and the first substrate layer, and Fₛ₁₁ is a peel force between the first housing and the first sealing material layer.

2. The electrochemical device according to claim 1, wherein the electrochemical device satisfies at least one of the following conditions:
$$( i ) {F}_{11} \geq 0.4 N / mm ;$$
$$( ii ) {F}_{s 11} \geq 1 N / mm ;$$
$$( iii ) {F}_{s 11} / {F}_{11} \geq 2.5 ; or$$
$$( iv ) {F}_{s 11} / {F}_{11} \leq 15.$$

3. The electrochemical device according to claim 1, wherein the first separation piece further comprises a second sealing material layer, and the first substrate layer is located between the first sealing material layer and the second sealing material layer; and
0.8≤F₁₁/F₁₂≤1.2, wherein F₁₂ is a peel force between the second sealing material layer and the first substrate layer.

4. The electrochemical device according to claim 1, wherein the first separation piece further comprises a second sealing material layer, and the first substrate layer is located between the first sealing material layer and the second sealing material layer; and
Fₛ₂₁/F₁₂≥≥1.2 and/or Fₛ₂₁/F₁₂≤15, wherein F₁₂ is a peel force between the second sealing material layer and the first substrate layer, and Fₛ₂₁ is a peel force between the second housing and the second sealing material layer.

5. The electrochemical device according to claim 1, wherein the first separation piece further comprises a second sealing material layer, and the first substrate layer is located between the first sealing material layer and the second sealing material layer; and
the electrochemical device further comprises at least one second separation piece; the second separation piece comprises a third sealing material layer, a fourth sealing material layer, and a second substrate layer located between the third sealing material layer and the fourth sealing material layer;
the electrochemical device satisfies at least one of the following conditions:
$$( a ) {F}_{s s} / {F}_{12} \geq 1.2 ;$$
$$( b ) {F}_{s s} / {F}_{21} \geq 1.2 ;$$
$$( c ) {F}_{s 22} / {F}_{22} \geq 1.2 ;$$
$$( d ) {F}_{p p} / {F}_{21} \geq 1.2 ;$$
$$( e ) {F}_{p p} / {F}_{22} \geq 1.2 ; or$$
$$( f ) 0.8 \leq {F}_{21} / {F}_{22} \leq 1.2 ,$$
wherein
F₁₂ is a peel force between the second sealing material layer and the first substrate layer, F₂₁ is a peel force between the third sealing material layer and the second substrate layer, Fₛₛ is a peel force between the third sealing material layer and the second sealing material layer, F₂₂ is a peel force between the fourth sealing material layer and the second substrate layer, Fₛ₂₂ is a peel force between the fourth sealing material layer and the second housing, and Fₚₚ is a peel force between two adjacent second separation pieces.

6. The electrochemical device according to claim 5, wherein the electrochemical device satisfies at least one of the following conditions:
$$( 1 ) {F}_{s s} / {F}_{12} \leq 15 ;$$
$$( 2 ) {F}_{ss} / {F}_{21} \leq 15 ;$$
$$( 3 ) {F}_{s 22} / {F}_{22} \leq 15 ;$$
$$( 4 ) {F}_{p p} / {F}_{21} \leq 15 ; or$$
$$( 5 ) {F}_{p p} / {F}_{22} \leq 15 .$$

7. The electrochemical device according to claim 3, wherein the first sealing material layer comprises a first seal region, and the second sealing material layer comprises a second seal region, and 0.9≤W₁/W₂≤1.1, wherein W₁ is a width of the first seal region, and W₂ is a width of the second seal region.

8. The electrochemical device according to claim 1, wherein the first substrate layer is made of a material comprising a metal, and the first sealing material layer is made of a material comprising a first polymer.

9. The electrochemical device according to claim 1, wherein the first electrode assembly and the second electrode assembly are connected in series.

10. The electrochemical device according to claim 7, wherein the first housing comprises a first cavity portion and a first peripheral portion, the first cavity portion is recessed away from the second housing to form a concave cavity, and the first peripheral portion surrounds the first cavity portion;
the second housing comprises a second cavity portion opposite to the first cavity portion and a second peripheral portion opposite to the first peripheral portion; and
the first seal region and the second seal region are located between the first peripheral portion and the second peripheral portion.

11. An electronic device, comprising an electrochemical device, the electrochemical device comprises:
a first housing;
a second housing;
a first separation piece, wherein the first separation piece is disposed between the first housing and the second housing; a first cavity and a second cavity are disposed on two sides of the first separation piece of the electrochemical device respectively; and the first separation piece comprises a first substrate layer and a first sealing material layer located on a surface of the first substrate layer;
a first electrode assembly, disposed in the first cavity; and
a second electrode assembly, disposed in the second cavity; wherein
Fₛ₁₁/F₁₁≥≥1.2, wherein F₁₁ is a peel force between the first sealing material layer and the first substrate layer, and Fₛ₁₁ is a peel force between the first housing and the first sealing material layer.

12. The electronic device according to claim 11, wherein the electrochemical device satisfies at least one of the following conditions:
$$( i ) {F}_{11} \geq 0.4 N / mm ;$$
$$( ii ) {F}_{s 11} \geq 1 N / mm ;$$
$$( iii ) {F}_{s 11} / {F}_{11} \geq 2.5 ; or$$
$$( iv ) {F}_{s 11} / {F}_{11} \leq 15.$$

13. The electronic device according to claim 11, wherein the first separation piece further comprises a second sealing material layer, and the first substrate layer is located between the first sealing material layer and the second sealing material layer; and
0.8≤F₁₁/F₁₂≤1.2, wherein F₁₂ is a peel force between the second sealing material layer and the first substrate layer.

14. The electronic device according to claim 11, wherein the first separation piece further comprises a second sealing material layer, and the first substrate layer is located between the first sealing material layer and the second sealing material layer; and
Fₛ₂₁/F₁₂≥≥1.2 and/or Fₛ₂₁/F₁₂≤15, wherein F₁₂ is a peel force between the second sealing material layer and the first substrate layer, and Fₛ₂₁ is a peel force between the second housing and the second sealing material layer.

15. The electronic device according to claim 11, wherein the first separation piece further comprises a second sealing material layer, and the first substrate layer is located between the first sealing material layer and the second sealing material layer; and
the electrochemical device further comprises at least one second separation piece; the second separation piece comprises a third sealing material layer, a fourth sealing material layer, and a second substrate layer located between the third sealing material layer and the fourth sealing material layer;
the electrochemical device satisfies at least one of the following conditions:
$$( a ) {F}_{s s} / {F}_{12} \geq 1.2 ;$$
$$( b ) {F}_{s s} / {F}_{21} \geq 1.2 ;$$
$$( c ) {F}_{s 22} / {F}_{22} \geq 1.2 ;$$
$$( d ) {F}_{p p} / {F}_{21} \geq 1.2 ;$$
$$( e ) {F}_{p p} / {F}_{22} \geq 1.2 ; or$$
$$( f ) 0.8 \leq {F}_{21} / {F}_{22} \leq 1.2 ,$$
F₁₂ is a peel force between the second sealing material layer and the first substrate layer, F₂₁ is a peel force between the third sealing material layer and the second substrate layer, Fₛₛ is a peel force between the third sealing material layer and the second sealing material layer, F₂₂ is a peel force between the fourth sealing material layer and the second substrate layer, Fₛ₂₂ is a peel force between the fourth sealing material layer and the second housing, and Fₚₚ is a peel force between two adjacent second separation pieces.

16. The electronic device according to claim 15, wherein the electrochemical device satisfies at least one of the following conditions:
$$( 1 ) {F}_{s s} / {F}_{12} \leq 15 ;$$
$$( 2 ) {F}_{ss} / {F}_{21} \leq 15 ;$$
$$( 3 ) {F}_{s 22} / {F}_{22} \leq 15 ;$$
$$( 4 ) {F}_{p p} / {F}_{21} \leq 15 ; or$$
$$( 5 ) {F}_{p p} / {F}_{22} \leq 15 .$$

17. The electronic device according to claim 13, wherein the first sealing material layer comprises a first seal region, and the second sealing material layer comprises a second seal region, and 0.9≤W₁/W₂≤1.1, wherein W₁ is a width of the first seal region, and W₂ is a width of the second seal region.

18. The electronic device according to claim 11, wherein the first substrate layer is made of a material comprising a metal, and the first sealing material layer is made of a material comprising a first polymer.

19. The electronic device according to claim 11, wherein the first electrode assembly and the second electrode assembly are connected in series.

20. The electronic device according to claim 17, wherein the first housing comprises a first cavity portion and a first peripheral portion, the first cavity portion is recessed away from the second housing to form a concave cavity, and the first peripheral portion surrounds the first cavity portion;
the second housing comprises a second cavity portion opposite to the first cavity portion and a second peripheral portion opposite to the first peripheral portion; and
the first seal region and the second seal region are located between the first peripheral portion and the second peripheral portion.
